(19) United States
(12) Patent Application Publication
(10) Pub. No.: US 2024/0149534 A1
(43) Pub. Date: May 9, 2024

(54) INSTALLATION FOR WELDING PARTS MADE OF THERMOPLASTIC COMPOSITE MATERIALS, AND METHOD FOR OPERATING SAME

(71) Applicant: LATECOERE, Toulouse (FR)

(72) Inventor: Jean Michel Borlot, Teulat (FR)

(73) Assignee: LATECOERE, Toulouse (FR)

(21) Appl. No.: 18/549,017

(22) PCT Filed: Mar. 9, 2022
(86) PCT No.: PCT/EP2022/055990

§ 371 Date: Sep. 5, 2023

(30) Foreign Application Priority Data
Mar. 15, 2021 (FR) FR2102568

(51) Int. Cl. B29C 65/36; B29C 65/72

(52) U.S. Cl. CPC B29C 65/3696; B29C 65/72; B29K 2101/12

(57) ABSTRACT

An installation for welding a stack of parts made of thermoplastic composite materials (20) in a local welding plane (P), this installation including an electromagnetic induction head (8), pairs of elements for guiding and pressing the workpiece stack (20) in this local plane (P), and, on each side of the induction head (8), at least one pair of guide elements, each pair of guide elements having a lower guide element (14) and an upper guide element (10) that are superposed, receiving between one another the stack of parts (20) by guiding it in the direction perpendicular to the local welding plane (P).

### CROSS REFERENCE TO RELATED APPLICATION

This application is a national stage entry of PCT/EP2022/055990 filed Mar. 9, 2022, under the International Convention and claiming priority over French Patent Application No. FR2102568 filed Mar. 15, 2021.

### TECHNICAL FIELD

The present invention relates to an installation for welding parts made of thermoplastic composite materials, and to a method for operating such an installation.

Certain parts made of composite material containing a single thermoplastic material or a plurality of thermoplastic materials and current-conducting elements, such as reinforcing fibers made of carbon, can be welded together by applying a localized magnetic field that creates current loops in the conductive materials generating heating that makes it possible to reach the melting point of the thermoplastic materials.

In order to implement this method, two parts having mutually compatible thermoplastic materials are superposed, then an electromagnetic induction head is displaced above the weld zone in order to obtain, by activating this head, the melting point, pressing these two parts together immediately following the melting making it possible to achieve cohesion between the welded parts.

This type of method makes it possible to produce parts with large dimensions, which may have curvatures, exhibiting both good stiffness and considerable lightness, in particular aircraft elements, such as doors for the passenger cabins or the holds, or elements of the fuselage such as fairing panels.

### PRIOR ART

A known installation for welding parts made of thermoplastic composite materials, which is presented in particular by patent document FR-A1-3018725, has a rigid structure that receives an insulating baseplate permeable to electromagnetic waves, comprising a non-magnetic material, and equipped with tools for positioning and holding the parts to be welded. The two parts to be welded are installed with interposition of a metal insert receptive to the magnetic field, the whole being covered by a vacuum bladder.

A magnetic induction head is then displaced automatically over the top of the bladder in order to generate, over its path, a rise in temperature that makes it possible to melt the thermoplastic materials, pressing of the parts by the vacuum ensuring the cohesion of these parts.

However, this type of method requires the putting in place, under the parts to be welded, of a non-magnetic insulator supported by the chassis, and this prevents access below these parts at the location of the weld. Now, such access is very useful, in particular for taking measurements that make it possible to monitor the welding with precision and therefore to optimize it.

In addition, the non-magnetic material subjected to high thermal stresses is difficult to produce, in particular for large dimensions that are necessary for receiving parts having welds over considerable lengths. This material in contact with the parts to be welded also causes thermal flows that make it difficult to precisely and uniformly control the melting point of the parts during welding, and this can degrade the quality of the weld. It is possible to provide an internal circuit for circulation of a cooling fluid so as to improve control of the thermal flows, but this circuit is complex to produce.

In addition, the displacement of the induction head in space requires a robotic system, in particular a robotic arm with six axes of displacement. Such an arm is complex to produce and to control, and leads to high production costs.

Another known installation for welding parts made of composite materials, which is presented in particular by patent document FR-A1-3083732, has a mobile induction head that is displaced above the two parts to be welded, with a magnetic blade forming an insert disposed between these parts, which follows the displacement of the head in order to permanently have, under this head, an element receiving the magnetic field causing the heating between the two parts.

The metal blade thus imparts its heat to the parts so as to melt the surfaces in contact, pressing rollers pressing on the top part, following the displacement so as to achieve cohesion of the weld. This method requires a rigid lower reaction surface under the pressing rollers, which also poses problems of thermal control. A variant has two pressing rollers disposed opposite one other on either side of the two parts to be welded, downstream of the weld.

It is difficult for this installation to ensure the precise positioning of the welding zone with respect to the induction head, in particular for stacks of parts having curved shapes in the vertical direction. In this case, it is necessary to have complementary means for measuring the parts, or to carry out complex calculations.

Other welding installations, which are described, in particular, in US 2003/062118A1 and DE 100 00 347A1, comprise an electromagnetic induction head and, on each side of this head, superposed members, respectively one upper and one lower, for guiding a stack of parts in the direction perpendicular to the local welding plane.

However, in these installations, the induction head is fixed and its height relative to the stack is kept constant by the guide members. Consequently, the head cannot adapt to the curvature of the stack.

### SUMMARY OF THE INVENTION

The present invention aims in particular to avoid these problems of the prior art, through a simple implementation ensuring in particular precise positioning of the welding zone with respect to the induction head. To this end, it proposes having a welding installation with guiding of the stack of parts to be welded, and not necessarily of the induction head. Such an installation can receive parts having varied curvatures, and makes it easier to control the quality of the welds through the absence of a baseplate for positioning the parts to be welded.

More precisely, the present invention relates to an installation for welding a stack of parts made of thermoplastic composite materials in a local welding plane, this installation having an electromagnetic induction head and guides for guiding the stack of parts in this welding plane, with, on each side of the induction head, at least one guide pair, each guide pair comprising a lower guide and an upper guide that are superposed and are able to receive between them the stack of parts by guiding it in the direction perpendicular to the local welding plane.

An advantage of this welding installation is that by disposing, on either side of the induction head, guides that receive the parts between them, it is easy, leaving the induction head at a fixed height, to both guide the welding zone in terms of height relative to this head, and press the parts at least downstream of the weld.

In addition, by adapting the height of each guide pair, it is possible to pass parts having curvatures, with direct adjustment of the local welding plane with respect to the induction head. An economical and easy to control installation is obtained, having an induction head that can remain fixed on an axis perpendicular to the local welding plane.

The welding installation according to the invention may advantageously also have one or more of the following preferred features, which may be combined with one another.

Advantageously, each lower guide and upper guide of the guide pairs are able to move in the direction perpendicular to the local welding plane.

In this case, advantageously, each guide pair has at least one lower guide or one upper guide equipped with a system for regulating the displacement of its movement in the direction perpendicular to the local welding plane.

Advantageously, at least one guide pair has a system for regulating the pressure that is able to be exerted on the stack between the lower guide and the upper guide.

Advantageously, each lower guide and upper guide has a device for rolling against the stack having axes parallel to the local welding plane.

In this case, advantageously, the lower guide and upper guide have pressing rollers comprising a filled silicone coating.

Advantageously, at least one guide pair has a device for displacing a lower guide or upper guide with respect to the other in the direction of the local welding plane.

In this case, advantageously, the welding installation has a system for regulating the device for displacement in the direction of the local welding plane according to the curvature of the stack, ensuring perpendicularity of the pressure with respect to the surfaces.

Advantageously, the induction head has a device for vertically positioning this head.

In particular, the welding installation may have a support connected to a fixed structure by the device for vertically positioning the head, which also supports the upper guides of the guide pairs.

Advantageously, the welding installation has a mobile holding and positioning frame intended for the stack of parts, displacing the zone to be welded of this stack under the induction head.

Advantageously, the welding installation has heating or cooling air jets disposed between the lower guides.

Advantageously, the welding installation has means for measuring the welding zone that are disposed between the lower guides.

In particular, the measuring means may be chosen from a visual or thermal camera, optical fibers coupled to a pulse rangefinder, and/or position or distance sensors.

In addition, advantageously, the welding installation has a system for continuously regulating parameters for adjusting its operation according to data supplied by the measuring means.

The invention also relates to a method for operating a welding installation as defined above, this method adjusting, in real time, the height of each guide pair according to the progression of the stack of parts during welding.

In the present text, the qualifier “vertical”, respectively “horizontal”, relates to an object in use mode having an orientation, a displacement or a positioning of axis perpendicular to the ground, respectively along an axis parallel to the ground. In addition, “upper”, respectively “lower”, describes, in use mode, a roller arranged above the welding plane, respectively below this plane. “Below”, respectively “above”, relates to a relative positioning closer to the ground, respectively further from the ground, in use mode.

### BRIEF DESCRIPTION OF THE DRAWINGS

The invention will be better understood and other features and advantages will become apparent in detail upon reading the following description given by way of non-limiting example, with reference to the appended drawings that respectively depict:

FIG. 1 shows a schematic front view of a welding installation according to the invention;

FIG. 2 this installation producing a weld on flat parts;

FIG. 3 this installation equipped with action or measuring instrumentation disposed below the parts; and

FIG. 4 this installation producing a weld on curved parts.

### DETAILED DESCRIPTION OF THE INVENTION

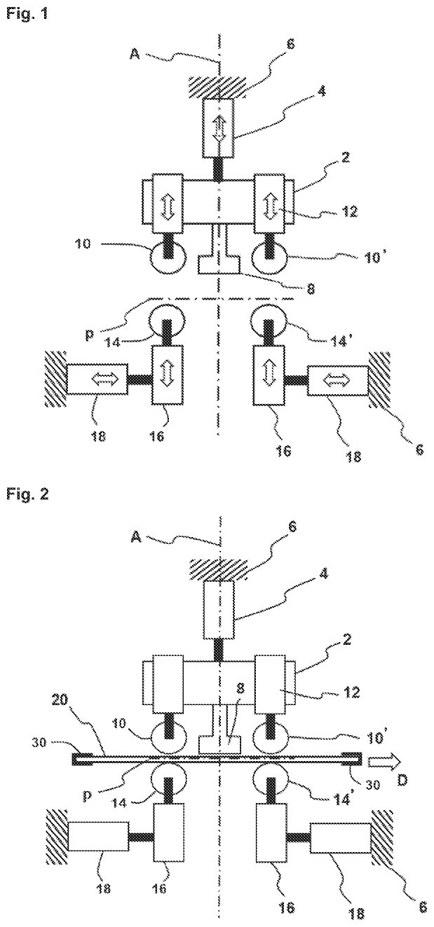

FIG. 1 shows a support 2 connected by a device for vertically displacing the head 4 that is fixed to a structure 6, allowing displacement of this support along a vertical axis A. The support 2 receives, underneath, an induction head 8 disposed along the vertical axis A, which makes it possible to heat and to produce a weld in a horizontal local welding plane P formed just below this head 8.

The support 2 receives, symmetrically on each side of the induction head 8, an upper pressing roller 10, 10′ fixed under a device for vertically positioning the upper roller 12 that is connected to the support 2. The two upper pressing rollers 10, 10′ have parallel axes, which are disposed parallel to the local welding plane P.

Each upper roller 10, 10′ has, underneath, a lower roller 14, 14′ connected to the structure 6 successively by a device for vertically positioning the lower roller 16 and then by a device for horizontally positioning the lower roller 18.

Each upper roller 10, 10′ forms a guide pair with its lower roller 14, 14′ positioned facing it. In the example illustrated, the pair of pressing rollers 10′, 14′ forms the upstream guide pair and the pair of pressing rollers 10, 14 forms the downstream guide pair. More generally, upstream and downstream of the induction head 8 with respect to the direction of progression D (cf. FIG. 2) of the parts to be welded, one or more guide pairs are arranged to form, respectively, an upstream guide pair and a downstream guide pair.

The various displacement and positioning devices 4, 12, 16, 18 may have any type of actuator allowing translational movement, such as an electric ram or a hydraulic or pneumatic fluid ram, comprising in particular a digitized control, making it possible to obtain, in real time, for these devices, a displacement regulation from a position setpoint, or a pressure regulation from a force setpoint.

In this way, for each guide pair having an upper roller 10, 10′ and a lower roller 14, 14′ that are disposed opposite one another, between these rollers, both defined clamping of the superposed parts and precise vertical positioning at this clamping point are obtained.

FIG. 2 shows a stack of superposed flat parts 20, which is advantageously held inside a rigid frame 30. The frame 30 is displaced in space with a digitized drive means, not shown, in order to make the zone to be welded progress under the induction head 8 along the linear progression D so as to obtain a continuous weld bead.

The zone to be welded of the stack 20 is clamped on both sides of the induction head 8 by the upper rollers 10, 10′ and lower rollers 14, 14′ of each guide pair, which are situated upstream and downstream in the direction of progression D, with a height for each pair that is adjusted in order to adjust the height of this zone with respect to the local welding plane P. In this way, with the frame 30, global positioning of the stack 20, comprising the displacement of the zone to be welded in the local welding plane P, and precise positioning in terms of height of this zone with the two welding systems ensuring the necessary distance under the electromagnetic induction head 8 are obtained.

Advantageously, there is carried out, for each guide pair, regulation of vertical displacement on one of the rollers, ensuring the positioning of the stack 20, and regulation of pressure on the other roller so as to ensure the necessary clamping of this stack.

The device for vertically displacing the head 4 makes it possible in particular to lift, over a considerable travel, the support 2 with the induction head 8 and the two upper rollers 10, 10′ so as to introduce the stack of parts 20 underneath without being hindered. It then makes it possible to precisely bring the base of the induction head 8 to the desired distance from the local welding plane P, which may vary according to the parts to be welded, or during welding of a single stack 20 with its progression D, comprising technical features of the areas to be welded that vary as the weld progresses.

It is possible in particular to provide two types of drive for the device for displacing the head 4, comprising a rapid drive over a long travel to clear the space under the induction head 8, then a slower and more precise drive over a short travel to adjust the optimal induction distance, which can be added to an adjustment in terms of height given by the guide pairs with rollers 10, 14 and 10′, 14′.

Advantageously, the pressing rollers 10, 10′, 14, 14′ have a slightly flexible coating that makes it possible to adapt to large radii of the stack of the parts 20 and ensures adhesion and distribution of the pressure preventing marking of these parts. In particular, a polymer that is resistant to high temperatures, above 300°, and does not cause magnetic disturbance of the field emitted by the induction head 8, such as a filled silicone, is used.

The pairs of rollers 10, 14 and 10′, 14′ also make it possible to rotate the stack of parts 20 in the local welding plane P according to a large radius, which rotation is given by a movement of the frame 30 during the progression D, so as to produce a curved weld line in this plane.

The downstream pair of rollers 10, 14 also carries out calibrated pressing of the stack 20 that has just been heated in order to ensure cohesion of the weld by adjusting the pressure in the molten zone during its cooling. The clamping pressure may vary continuously as a function of the technical features of the zone to be welded of the parts, which zone may change in a single stack 20.

As a variant, it is possible to produce guide pairs comprising other clamping means allowing lateral movement of the stack of parts 20, having for example a plurality of rollers disposed next to one another, or a caterpillar track system surrounding rollers in order to distribute the clamping pressure over a larger surface area.

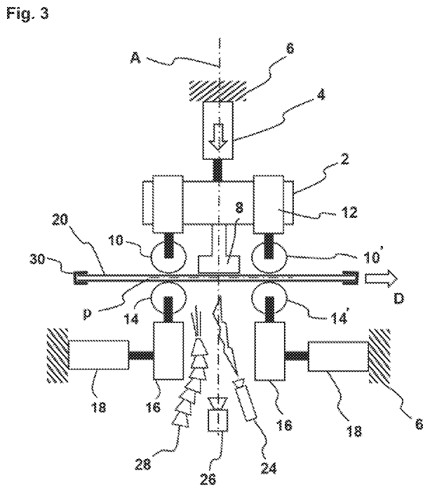

FIG. 3 shows instrumentation disposed directly under the stack 20, facing the induction head 8 between the two lower rollers 14, making it possible to dispose, as close as possible to the heated zone, action means or measuring means in order to obtain precise information representative of the physical state of this zone.

It should be noted that the relative spacing of the pairs of rollers 10, 14 and 10′, 14′ situated on either side of the induction head 8 frees up this lower space, by distancing the masses of the rollers that could disturb the physical phenomena at the melting zone, such as the magnetic field or thermal propagation.

In particular, it is possible to dispose jets of air 24 for heating or cooling the stack 20, a visual or thermal camera 26, optical fibers 28 connected to a pulse rangefinder, for example a laser rangefinder, or position or distance sensors. The measurements taken advantageously make it possible to continuously control the various operating parameters of the welding installation, which comprise in particular the speed of progression of the stack D, the electromagnetic energy supplied by the induction head 8, the precise distance of this head and/or the clamping force of the downstream guide pair 10, 14. A high level of quality of the weld, which is guaranteed, is thus obtained.

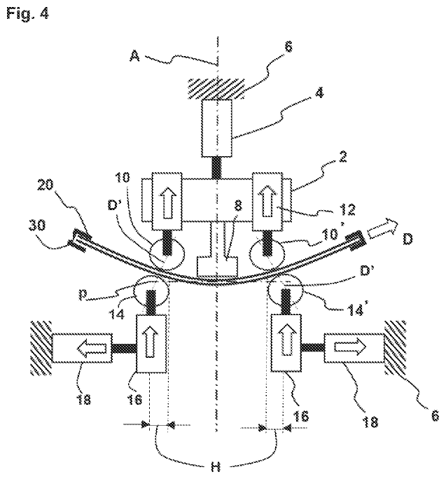

FIG. 4 shows a curved stack of parts 20 having a large radius of curvature in a plane perpendicular to the local welding plane P, such that the progression D remains, at discrete points, close to a linear progression. In this case, the devices 18 for horizontally positioning the lower rollers 14, 14′ are adjusted with a displacement H so as to obtain, at each point of the stack 20, for each guide pair, a straight line D′ passing through the axis of its upper roller 10, 10′ and its lower roller 14, 14′ that is substantially perpendicular to the surface of the stack at this location. In this way, with an adjustment of the horizontal positioning devices 18 that can change in real time according to the radii of the curved stack 20, optimum clamping is obtained that does not deform the parts by virtue of this clamping that always remains perpendicular to the surfaces.

At the same time, the height of each guide pair is adjusted so as to keep the zone to be welded in the local welding plane P, taking into account the radius of curvature of the curved stack 20, and this makes it possible to maintain the optimum quality of the weld.

As a variant, it is possible to use a horizontal positioning device on the upper rollers 10 that, in the same way, would make it possible to modify the angle of the straight line passing through the axis of the rollers of each guide pair.

In general, there is obtained, with the two guide pairs disposed on either side of the induction head, as close as possible to this head, a robust, precise and reactive means for adjusting the height of the zone to be welded at each location independent of the dispersions or flexibilities of the stack 20, which can be considerable in large parts made of thermoplastic materials. Continuous digital control of all the movements of the welding installation, and of the parameters of the weld such as the frequency and intensity of the electromagnetic field, defined beforehand in a welding scenario, with modulations given by continuous control, makes it possible to optimize both the time and the quality of the weld.

The invention is not limited to the examples described and illustrated. In particular, the thermal or visual welding control means can be combined with control installations conventionally situated in the upper position—before the upstream roller, between the rollers, or after the downstream roller. In particular, the thermal control air jets can be placed in any suitable location (before, between or after the upper or lower rollers, and/or else laterally).

It is also possible to replace the downstream rollers with thermally regulated pads, jointly (two downstream pads) or separately by combining a pad with a facing roller. It may also be appropriate to add one or more heated “chambers” around the one or more rollers or the pads, in order to ensure thermal control of the welded zone downstream of the induction head. These chambers will be connected to the rollers or pads and will ensure sufficiently hermetic contact with the parts to be welded.

1. An installation for welding a stack of parts made of thermoplastic composite materials (20) in a local welding plane (P), the installation having an electromagnetic induction head (8) and, on each side of said induction head, at least one pair of guides (10, 14; 10′, 14′), each pair comprising, respectively, a lower guide (14, 14′) and an upper guide (10, 10′) that are superposed and are able to receive between them the stack of parts (20) by guiding in the direction perpendicular to the local welding plane (P),
wherein at least one guide pair has a device for displacing the lower guide (14, 14′) or upper guide (10, 10′) with respect to the other in the direction of the local welding plane (P) and a system for regulating said displacement device according to the curvature of the stack (20) so as to ensure perpendicularity of the pressure with respect to the surfaces.

2. The welding installation as claimed in claim 1, wherein each lower guide (14, 14′) and upper guide (10, 10′) of the guide pairs are able to move in the direction perpendicular to the local welding plane (P).

3. The welding installation as claimed in claim 2, wherein each guide pair has at least one of the lower guide (14, 14′) and/or one of the upper guide (10, 10′) is equipped with a system for regulating the displacement of movement in the direction perpendicular to the local welding plane (P).

4. The welding installation as claimed in claim 1, wherein the at least one guide pair has a system for regulating the pressure exerted on the stack (20) between the lower guide (14, 14′) and the upper guide (10, 10′).

5. The welding installation as claimed in claim 1, wherein each one of the lower guide (14, 14′) and the upper guide (10, 10′) has a rolling device for rolling against the stack (20) having axes parallel to the local welding plane (P).

6. The welding installation as claimed in claim 5, wherein each one of the lower guide (14, 14′) and the upper guide (10, 10′) have pressing rollers comprising a filled silicone coating.

7. The welding installation as claimed in claim 1, wherein the induction head (8) has a device for vertically positioning the head (4).

8. The welding installation as claimed in claim 7, wherein a support (2) connected to a fixed structure (6) by the device for vertically positioning the head (4), which also supports the upper guides (10, 10′) of the guide pairs.

9. The welding installation as claimed in claim 1, further including a mobile holding and positioning frame (30) for the stack of parts (20), displacing the zone to be welded of this stack (20) under the induction head (8).

10. The welding installation as claimed in claim 1, further including heating or cooling air jets (24) disposed between the lower guides (14, 14′).

11. The welding installation as claimed in claim 1, further including a measuring device for measuring the welding zone that are disposed between the lower guides (14, 14′).

12. The welding installation as claimed in claim 11, wherein the measuring device is chosen from a visual or thermal camera (26), an optical fibers (28) connected to a pulse rangefinder, and/or position or distance sensors.

13. The welding installation as claimed in claim 11, wherein a system for continuously regulating parameters for adjusting an operation according to data supplied by the measuring device.

14. A method for operating a welding installation as claimed in claim 1, the method comprising the step of adjusting in real time, the height of each guide pair (10, 14; 10′, 14′) according to the progression (D) of the stack of parts (20) during welding.
